(19) United States
(12) Patent Application Publication
(10) Pub. No.: US 2011/0157059 A1
(43) Pub. Date: Jun. 30, 2011

(54) Touch Display Panel and Touch Sensing Method Thereof

(75) Inventors: Chih-Wei Chen, Hsin-Chu (TW); Hai-En Tsai, Hsin-Chu (TW); Fu-Cheng Fan, Hsin-Chu (TW)

(73) Assignee: AU OPTRONICS CORPORATION, Hsin-Chu (TW)

(21) Appl. No.: 12/979,447

(22) Filed: Dec. 28, 2010

(30) Foreign Application Priority Data
Dec. 31, 2009 (TW) 098146560

(51) Int. Cl. G06F 3/041

(52) U.S. Cl. 345/173; 345/87; 345/107

(57) ABSTRACT

This disclosure relates to a touch display panel and more specifically to a borderless touch display panel. The touch display panel includes a Fresnel lens, a touch-sensing panel and a coordinate transforming module, wherein the flat display panel and the Fresnel lens are spaced apart by a distance. The flat display panel outputs an original image having an original coordinate system. The Fresnel lens is used to transform the original image into a display image to be viewed by the user, wherein the display image has a display coordinate system. The touch sensing panel will sense the user's touch and output a touch coordinate of a touch and the coordinate transforming module will transform the touch coordinate into an action coordinate based on a transformation parameter set. The transformation parameter set includes a magnification parameter and a shift parameter for compensating for the positional difference between the touch coordinate and the action coordinate due to the distance between the flat display panel and the Fresnel lens.

### BACKGROUND OF THE INVENTION

1. Field of the Invention

This invention relates to a touch display panel and a touch sensing method thereof, specifically to a borderless touch display panel and a touch sensing method thereof.

2. Description of the Prior Art

Recently, the touch display panel is widely used in electronic products such as liquid crystal televisions, personal computers, mobile phones and personal digital assistants. More and more touch display panels now have a borderless appearance featured in special aesthetics and increased display area and become more and more popular. Please refer to FIG. 1A, a top view of a conventional touch display panel 10 is illustrated, wherein the conventional touch display panel 10 includes a flat display panel 20 and a touch-sensing panel 40. As FIG. 1A shows, the area of the touch-sensing panel 40 is greater than the area of the flat display panel 20. The flat display panel 20 outputs images through the touch-sensing panel 40, wherein Fresnel lens (not illustrated) is disposed on one side of the touch-sensing panel 40 for magnifying the images from the flat display panel 20 to have an area equal to the area of the touch-sensing panel 40. In this way, the Fresnel lens on the touch-sensing panel 40 can be used to conceal the frame of the flat display panel 20 and provide a visual effect of borderless appearance by magnifying the images from the flat display panel. However, the conventional touch display panel with borderless appearance still has a certain issue regarding the detection of user's touch.

Please refer to FIG. 1B and FIG. 1C, cross-sectional views of the conventional touch display panel 10 under different using status are illustrated, wherein the conventional touch sensing display panel 10 selectively activates the borderless effect according to the using status. The conventional touch display panel 10 includes a flat display panel 20, Fresnel lens 30, and a touch-sensing panel 40, wherein the Fresnel lens 30 is disposed on one side of the touch-sensing panel 40 facing the flat display panel 20. When the touch-sensing panel 40 is touched at point A, the touch-sensing panel 40 will generate a sensing signal representing the location of point A and the location of the touch-sensing signal will be regarded as the vertical projection of point A on the flat display panel 20. As FIG. 1B shows, when the touch-sensing panel 40 is close to the flat display panel 20, the distance 90 between the flat display panel 20 and the Fresnel lens 30 is very small and thus the Fresnel lens 30 substantially does not magnify the image. Thus, the conventional touch display panel 10 does not exhibit the visual effect of borderless appearance. Furthermore, since the image on the active area 21 is not magnified, the touch point A on the touching sensing panel 40 substantially corresponds to an action point B on the flat display panel 20.

As FIG. 1C shows, the touch-sensing panel 40 and the Fresnel lens 30 are raised to a larger distance 90 from the flat display panel 20. Furthermore, the Fresnel lens 30 will magnify the image to have an area identical to the area of the touch-sensing panel 40 to provide the conventional touch display panel 10 with a borderless effect. In the mean while, the image at point C will be magnified to point A on the touch-sensing panel 40. In other words, a positional difference 92 will exist between the vertical projection B of point A on the flat display panel 20 and the action point C. If the above-mentioned positional difference 92 is not properly compensated, the touch point A will be incorrectly identified as the vertical projection B on the flat display panel 20. In this way, when the Fresnel lens 30 and the touch-sensing panel 40 are spaced apart from the flat display panel 20 by a certain distance, the touch-sensing result will differ from the location of user's touch.

### SUMMARY OF THE INVENTION

It is an object of the present invention to provide a touch display panel and a touch-sensing method thereof for improving the accuracy in detecting touch point under the borderless mode.

The touch display panel of the present invention includes a flat display panel, Fresnel lens, a touch-sensing panel, and a coordinate transforming module, wherein the touch-sensing panel includes a touch-sensing circuit for generating coordinates of touch points based on the user's touch. The flat display panel includes an active area, wherein the active area outputs an original image based an original coordinate system. The Fresnel lens is disposed on one side of the flat display panel having the active area and spaced apart from the active area by a distance, wherein the Fresnel lens transforms the original image into a display image based on a display coordinate system. The original coordinate system and the display coordinate system correspond to each other. A positional difference exists between a vertical projection of the original coordinate system on the Fresnel lens and the corresponding location on the display coordinate system.

The touch-sensing panel of the touch display panel is disposed on an outer side of the Fresnel lens. That is, the touch-sensing panel and the flat display panel are disposed on two opposite sides with respect to the Fresnel lens. When the user touches the touch-sensing panel at one touch point, the touch-sensing panel will output the display coordinate of the touch point which corresponds to the location in the display coordinate system. The coordinate transforming module is connected to the touch-sensing panel to receive the display coordinate of the touch point, wherein the coordinate transforming module transforms the display coordinate of the touch point into an original coordinate of an action point which corresponds to the original coordinate system. The transformation is based on a transformation parameter set which includes a magnification parameter and a shift parameter, wherein the coordinate transforming module selectively chooses at least one of the parameters based on the structure of the touch display panel to transform display coordinates of the touch point into appropriate original coordinates.

In different embodiments, the touch display panel includes an activation module and a sensor. The activation module selectively switches the transformation parameter set between a standard value and a default value. When the transformation parameter set is set at the default value, the positional difference between the display coordinate system and the original coordinate system is reduced to substantially zero. The sensor is disposed between the flat display panel and the Fresnel lens, wherein the sensor will generate an activation command to set the transformation parameter set at the standard value when detecting the distance between the flat display panel and the Fresnel lens beyond a predetermined value.

### BRIEF DESCRIPTION OF THE DRAWINGS

FIG. 1A is a top view of a conventional touch display panel;

FIG. 1B and FIG. 1C are cross-sectional views of the conventional touch display panel;

FIG. 2 is a top view of the touch display panel of the present invention;

FIG. 3 and FIG. 4 are cross-sectional views of the touch display panel at different status;

FIG. 5 and FIG. 6A are cross-sectional views of the touch display panel in another embodiment;

FIG. 6B and FIG. 7 illustrate variations of the touch display panel illustrated in FIG. 6A;

FIG. 8 is a flow chart of the touch sensing method of the present invention; and

FIG. 9 and FIG. 10 are variations of the touch sensing method in FIG. 8.

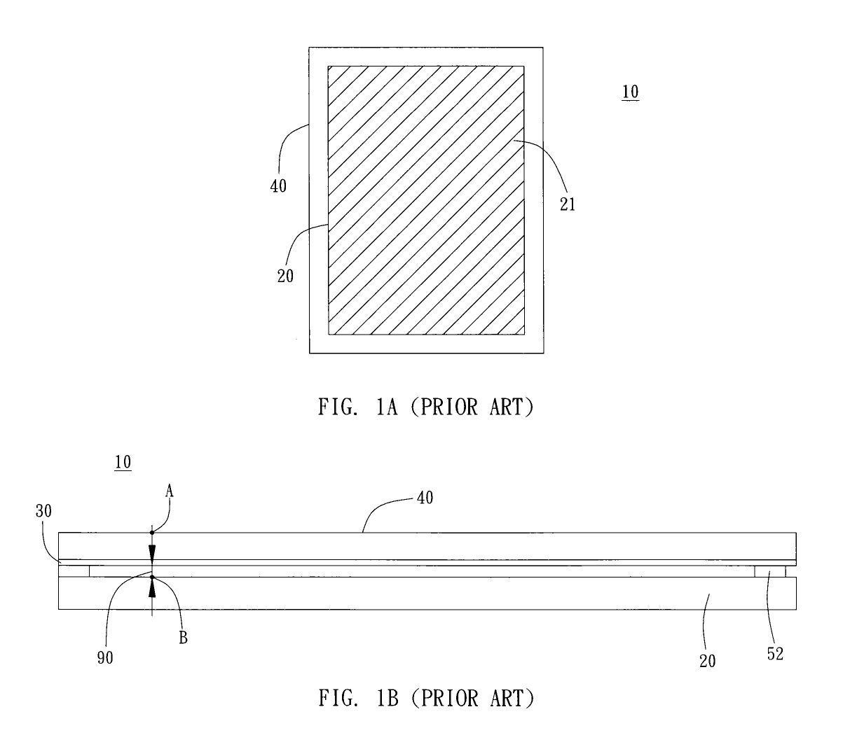

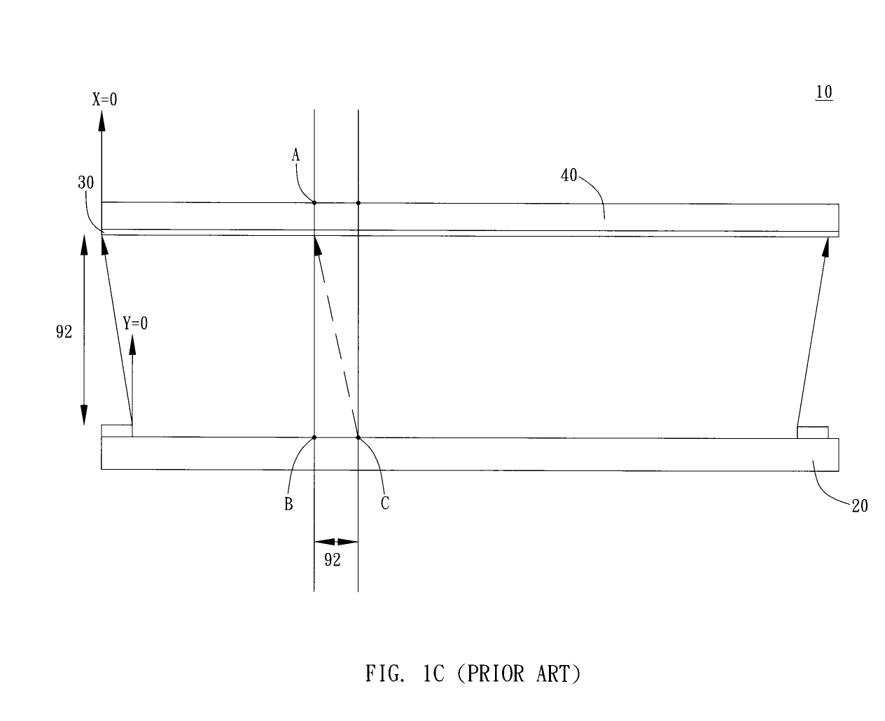

### DETAILED DESCRIPTION OF THE PREFERRED EMBODIMENT

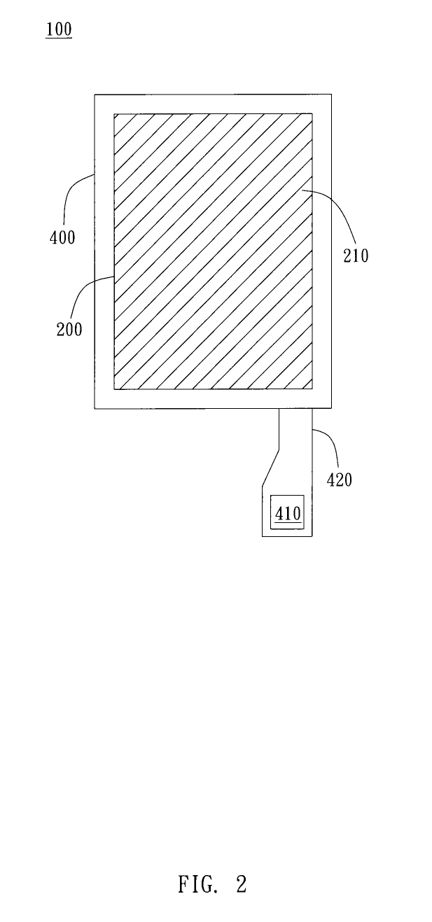

The present invention discloses a touch display panel and a touch sensing method thereof, specifically a borderless touch display panel and a touch sensing method thereof. FIG. 2 is a top view of the touch display panel 100 of the present invention, wherein the touch display panel 100 includes a flat display panel 200, a touch-sensing panel 400, a touch sensing circuit 410, and a signal wire cable 420, wherein two ends of the signal wire cable 420 are electrically connected to the touch-sensing panel 400 and the touch-sensing circuit 410, respectively. The flat display panel 200 includes an active area 210 for outputting an original image for the user to watch. Furthermore, a Fresnel lens (not illustrated) are disposed on the inner surface of touch-sensing panel 400 facing the flat display panel 200, wherein the Fresnel lens is used to magnify the original image to a display image. In other words, the display image outputted by the Fresnel lens is the actual image viewed by the user. In addition, the area of display image is greater than the area of the flat display panel 200 and substantially equal to the area of the touch-sensing panel 400. In this way, the image magnification effect of the Fresnel lens gives the user a borderless visual effect. Furthermore, the flat display panel 200 of the present embodiment is a liquid crystal display panel, but is not limited thereto; in different embodiments, the flat display panel 200 can include active light emitting display such as organic light emitting diode, passive light emitting display such as electrophoretic display, and other flat display panels such as print button.

As FIG. 2 shows, the touch-sensing panel 400 is used to sense the user's finger touch on its surface and transmit sensing signals to the touch-sensing circuit 410 through the signal wire cable 420 for further processing, but is not limited thereto. In different embodiments, the touch-sensing panel 400 can sense by contact by other object's such as a stylus and generate a touch point coordinate. Upon receiving the sensing signals, the touch-sensing circuit 410 calculates the coordinate of the touch point based on the sensing signals, wherein the coordinate of the touch point will be transmitted to the backend for further analysis. The flat display panel 200 and the touch-sensing panel 400 of the touch display panel 100 provide the user with an interface to input command by touching the image. Furthermore, the touch-sensing panel 400 is a capacitive touch-sensing panel 400, but is not limited thereto; in different embodiments, the touch-sensing panel 400 can include resistive touch-sensing panels, surface acoustic wave touch-sensing panels, infrared touch-sensing panels, and electromagnetic touch-sensing panels.

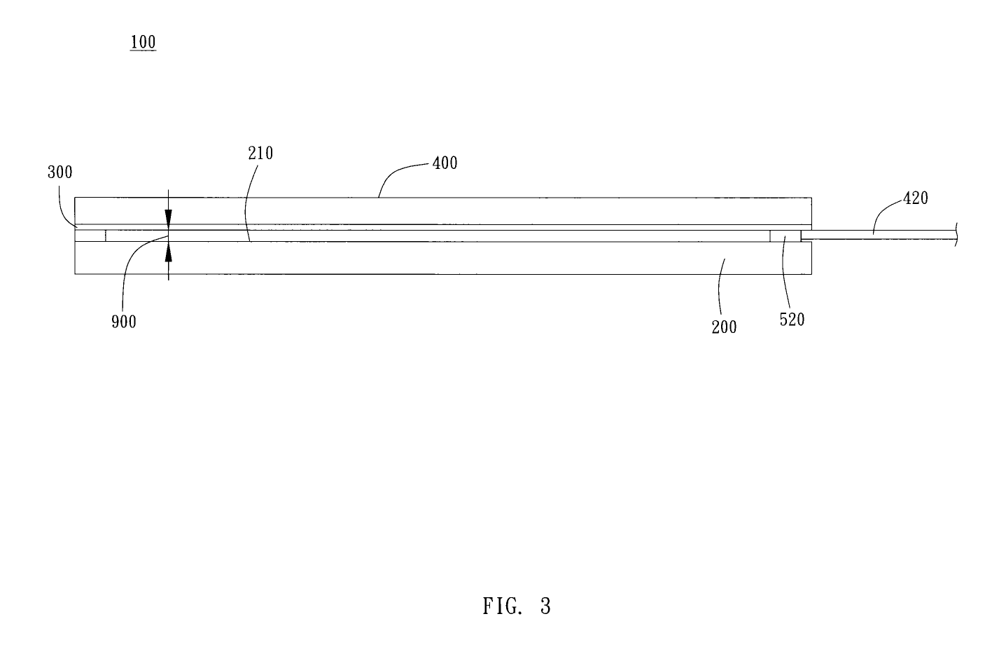

FIG. 3 is a cross-sectional view of the touch display panel 100 of the present invention. As FIG. 3 shows, the touch display panel 100 includes a flat display panel 200, Fresnel lens 300, a touch-sensing panel 400, a touch sensing circuit 410 (not shown), a signal wire cable 420, and a sensor 520, wherein the touch-sensing panel 400 and the sensor 520 are connected to the touch-sensing circuit 410 via the signal wire cable 420. The flat display panel 200 includes an active area 210 for outputting an original image toward the Fresnel lens 300 and the touch-sensing panel 400. The Fresnel lens 300 is disposed on one side of the touch-sensing panel 400 which faces the flat display panel 200 for magnifying the original image from the flat display panel 200 and generating the display image for users. In other words, the display image generated by the Fresnel lens 300 is the image viewed by the user and has an area greater than the area of the original image. In the embodiment illustrated in FIG. 3, the Fresnel lens 300 and the touch-sensing panel 400 are closely disposed on the flat display panel 200, and therefore the area of the display image generated by the Fresnel lens 300 and the area of the original image are substantially equal.

As FIG. 3 shows, the active area 210 of the flat display panel 200 and the Fresnel lens 300 are spaced apart from each other by a first distance 900, wherein the length of the first distance 900 will influence the magnification ratio of the Fresnel lens 300 magnifying the original image. When the Fresnel lens 300 is disposed at a location illustrated in FIG. 3, the original image is substantially not magnified by the Fresnel lens 300, and therefore the original image and the display image have substantially the same size. However, when the Fresnel lens 300 moves away from the flat display panel 200, the Fresnel lens 300 will magnify the original image and transform the original image into the magnified display image. In the embodiment illustrated in FIG. 3, an adjustable support device can be used to connect the Fresnel lens 300 and the touch-sensing panel 400 and configured to lift or lower the Fresnel lens 300 according to the using status of the touch flat display panel 100. In other words, the Fresnel lens 300 can selectively magnify the original image from the flat display panel 200 according to the using status of the touch display panel 100. As FIG. 3 shows, the original image of the flat display panel 200 has an original coordinate system, wherein the original coordinate system starts from one end of the flat display panel 200 as an origin and extends to the other end. Furthermore, the display image of the touch-sensing panel 400 has a display coordinate system, wherein the display coordinate system starts from one end of the touch-sensing panel 400 as an origin and extends to the other end. Furthermore, the original coordinate system and the display coordinate system respectively have original coordinates and display coordinates that are corresponding to each other, wherein a given point on the image has an original coordinate and a corresponding display coordinate.

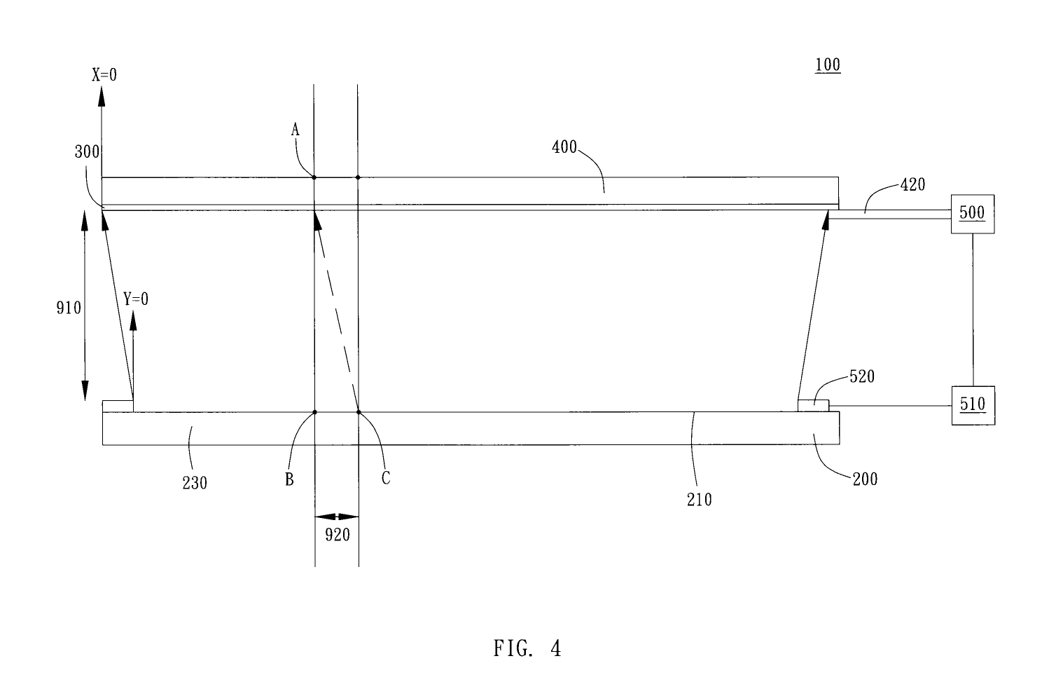

FIG. 4 is another cross-sectional view of the touch display panel 100 illustrated in FIG. 3, wherein the Fresnel lens 300 and the touch-sensing panel 400 are raised from the sensor 520. In this way, the Fresnel lens 300 and the active area 210 of the flat display panel 200 are spaced apart by a second distance 910, wherein the space between the active area 210 and the Fresnel lens 300 is an air layer, but is not limited thereto; in different embodiments, the above-mentioned space includes other type of transparent layers such as a vacuum layer. Furthermore, the second distance 910 can be adjusted based on the structure and the using status of the touch display panel 100. As FIG. 4 shows, the original image of flat display panel 200 has an original coordinate system, wherein the original coordinate system starts from one end of the flat display panel 200 as an origin and extends to the other end. Furthermore, the display image of the touch-sensing panel 400 has a display coordinate system, wherein the display coordinate system starts from one end of the touch-sensing panel 400 as an origin and extends to the other end. In addition, the display coordinate system has a display coordinate corresponding to the touch point A, and the original coordinate system has an original coordinate of the corresponding action point C, wherein the action point C and the touch point A correspond to the same point on the original image and the display image. In the embodiment illustrated in FIG. 4, the display coordinate of touch point A corresponds to the original coordinate of action point C. In other words, the touch point A and the action point C correspond to the same image. However, because of the magnification effect of the Fresnel lens 300, a positional difference 920 exists between the vertical projection B of the touch point A on the active area 210 and the corresponding action point C.

In order to compensate for the positional difference 920 between the vertical projection B of the touch point A on the active area 210 and the corresponding action point C, in the embodiment illustrated in FIG. 4, the touch display panel 100 further includes a coordinate transforming module 500 which converts the touch point A detected on the touch-sensing panel 400 to a corresponding action point C. The coordinate transforming module stores a transformation parameter set to transform the display coordinate of the touch point A into the original coordinate of the action point C. Furthermore, the touch-sensing circuit 410 adjusts the positional difference due to the raised Fresnel lens 300 based on the distance (second distance 910) between the active area 210 of the flat display panel 200 and the Fresnel lens 300. In other words, the sensor 520 is used to measure the second distance 910 and transmit the distance value of the second distance 910 to the coordinate transforming module 500 or the backend processor (such as the central processing unit) as a reference for transforming coordinates. Furthermore, in the present embodiment, the sensor 520 measures the second distance 910 at the time the first distance 900 is changed to the second distance 910, but is not limited thereto; in different embodiments, the sensor 520 can dynamically or periodically measure the second distance 910 and generate the distance data for the coordinate transforming module 500 or the backend processor (such as the central processing unit) to use as a reference for transforming coordinates. In the present embodiment, the coordinate transforming module 500 is a separate and independent module connected to the touch-sensing panel 400 via the signal wire cable 420, but is not limited thereto; in different embodiments, the coordinate transforming module 500 can also be embedded in the touch-sensing circuit 410 illustrated in FIG. 2.

In the embodiment illustrated in FIG. 4, when the Fresnel lens 300 is raised, the original image will be magnified by a factor of α, and therefore a positional difference 920 exists between the vertical projection B of the touch point A on the active area 210 and the corresponding action point C. In order to compensate for the above-mentioned positional difference 920, the coordinate transforming module 500 includes a magnification parameter α used to compensate for the coordinate difference induced by magnifying the original image. The touch display panel 100 further includes an activation module 510 connected to the coordinate transforming module 500 and the sensor 520. When the Fresnel lens 300 is raised from the active area 210 to have a second distance 910 between the active area 210 and the Fresnel lens 300, the sensor 520 will output an activation command to the activation module 510 which then sets the transformation parameter at a standard value. The coordinate transforming module 500 then transforms the display coordinate of the touch point A into the original coordinate of the action point C according to the standard value. In the present embodiment, the standard value is set at a while the coordinate transforming module 500 obtains the coordinate of the action point C by dividing a distance between the touch point A and the origin by α. In this way, even if the original image is magnified by the Fresnel lens by a factor of α, the coordinate transforming module 500 can still correctly transform the display coordinate of the touch point A into the original coordinate of the action point C based on the standard value of the transformation parameter set. Furthermore, when the Fresnel lens 300 and the touch-sensing panel 400 are lowered to a position as illustrated in FIG. 3, the activation module 510 will detect that the first distance 900 less than a given value exists between the Fresnel lens 300 and the active area 210 of the flat display panel 200 and set the transformation parameter at a default value. In the present embodiment, the original image of the flat display panel 200 now has the same area as the area of the display image of the touch-sensing panel 400, therefore the default value is set at 1, but is not limited thereto; in different embodiments, the default value can be adjusted according to the magnification of the original image by the Fresnel lens 300 at the default position.

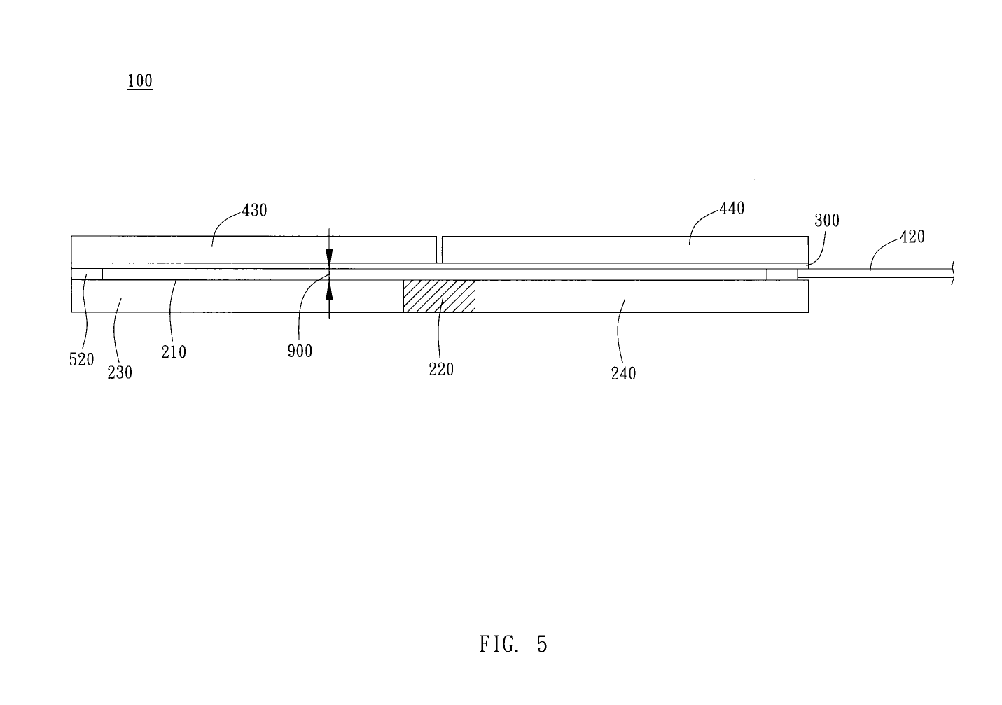

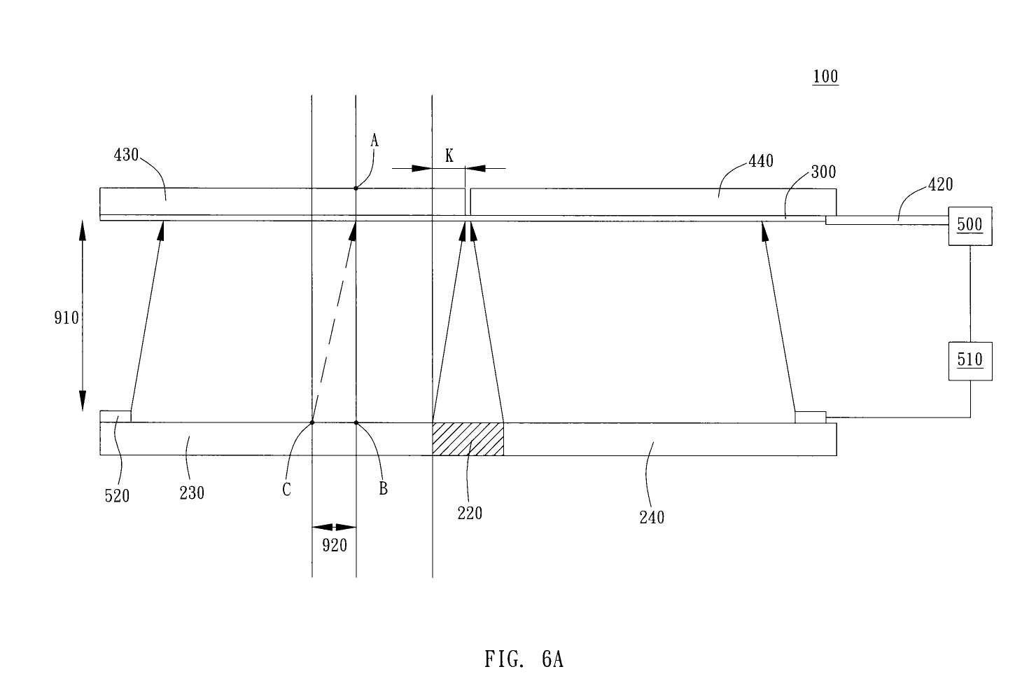

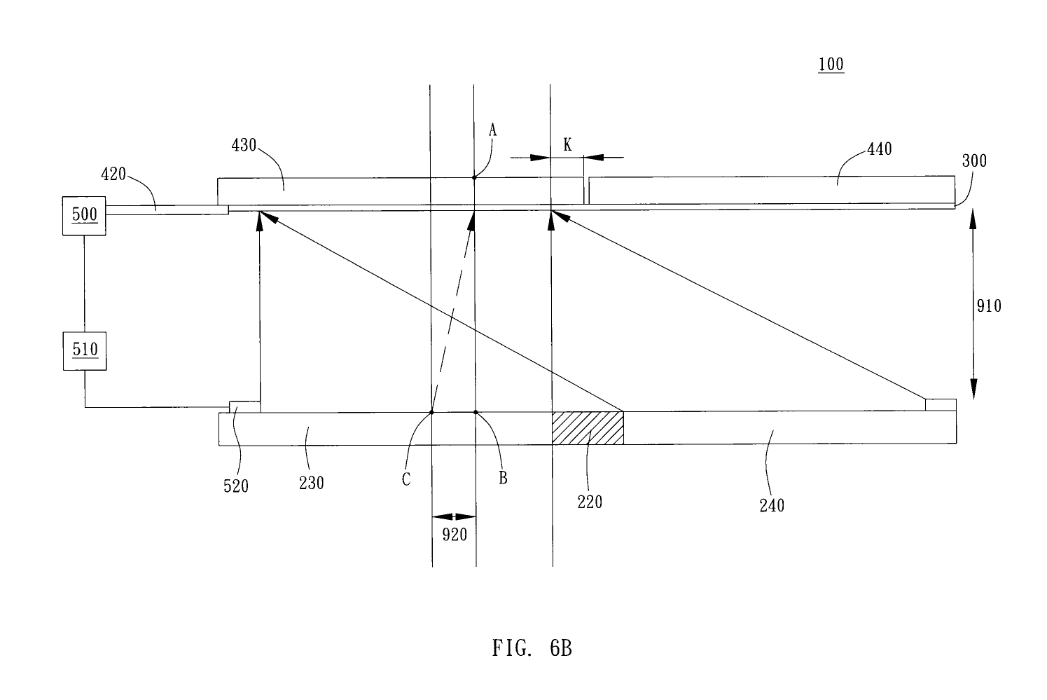

FIG. 5 and FIG. 6A illustrates another embodiment of the touch display panel 100 of the present invention. As FIG. 5 and FIG. 6A show, the flat display panel 200 includes a first flat panel 230 and a second flat panel 240 disposed side by side, wherein a spacer 220 is disposed between the first flat panel 230 and the second flat panel 240. The touch-sensing panel 400 includes a first touch-sensing panel 430 and a second touch-sensing panel 440 corresponding to the first flat panel 230 and the second flat panel 240, respectively. The Fresnel lens 300 is disposed on the surface of the first touch-sensing panel 430 and the surface of the second touch-sensing panel 440 which face the first flat panel 230 and the second flat panel 240, respectively. The first touch-sensing panel 430 and the second touch-sensing panel 440 output sensing signals when detecting user's touch.

In the embodiment illustrated in FIG. 5 and FIG. 6A, the first flat panel 230 and the second flat panel 240 are both thin-film transistor liquid crystal display (TFT-LCD panels, but are not limited thereto; in different embodiments, the first flat panel 230 and the second flat panel 240 can be a combination of the thin-film transistor liquid crystal panel and other types of displays such as a non-active display (such as electrophoretic display, EPD), a combination of a TFT-LCD panel and a printed button, a combination of a non-active display and a print button.

In the embodiment illustrated in FIG. 5, the Fresnel lens 300 is closely disposed on the surfaces of the first flat panel 230 and the second flat panel 240, therefore the Fresnel lens 300 substantially does not magnify the original image of the flat display panel 200 and the user will be able to see the spacer 220 between the first flat panel 230 and the second flat panel 240. In order to visually conceal the spacer 220 from the user, in the embodiment illustrated in FIG. 6A, the first touch-sensing panel 430 and the second touch-sensing panel 440 are raised so that a second distance 910 is kept between the display panels 230, 240 and the Fresnel lens 300. As such, the Fresnel lens 300 accepts the original images from the panels 230, 240 and outputs corresponding display images.

In the embodiment illustrated in FIG. 6A, the Fresnel lens 300 and the touch-sensing panels 430, 440 are raised so that a second distance 910 is kept between the active area 210 and the Fresnel lens 300. The Fresnel lens 300 will accept the original images form the first flat panel 230 and the second flat panel 240 and output the display images from the surfaces of the touch-sensing panels 430, 440 opposite to the Fresnel lens 300. Furthermore, the original image near the spacer 220 will be received by the portions of the Fresnel lens 300 at the edge of the first touch-sensing panel 430 and the second touch-sensing panel 440. In other words, the original images of the first flat panel 230 and the second flat panel 240 are shifted by a distance of k, wherein the distance k may vary with the distance between the Fresnel lens 300 and the display panels 230, 240. In this way, the Fresnel lens 300 will also shift the original image toward the interface of the touch-sensing panels 430, 440 and visually conceal the spacer 220. The display coordinate of the touch point A substantially corresponds to the original coordinate of the action point C on the active area 210 and not the original coordinate of the vertical projection B of the touch point A. However, without proper compensation, the sensing signal generated by the touch-sensing panel 400 based on the coordinate of the touch point A will be incorrectly identified by the coordinate transforming module 500. In other words, when the coordinate transforming module 500 obtains the coordinate of the touch point A, a distance 920 will exist between the coordinate of the vertical projection B and the coordinate of the action point C.

In order to compensate for the above-mentioned distance 920, the transformation parameter set of the coordinate transforming module 500 includes a shift parameter k for compensating the shift of image due to the raised Fresnel lens 300. In the embodiment illustrated in FIG. 6A, when the Fresnel lens 300 is raised to shift the original image and transforms the original image into the display image, the coordinate transforming module 500 will shift the display coordinate of the touch point A by a distance of k to the original coordinate of the action point C which is based on the original coordinate system. It can thus be seen that the coordinate transforming system 500 uses the shift parameter k to compensate for the positional difference 920 between the original coordinate system and the display coordinate system caused by the spacer 220 so that the display image touched by the user can be correlated to the correct portion of the original image.

FIG. 6B illustrates a variation embodiment of the touch display panel 100 illustrated in FIG. 6A. In the embodiment illustrated in FIG. 6B, the original images outputted by the first flat panel 230 and the second flat panel 240 are both inputted into the Fresnel lens 300 located corresponding to the first flat panel 230. The original images outputted by the two panels 230, 240 overlap in the space between the panels 230, 240 and the Fresnel lens 300 to create a 3-dimensional visual effect via the first touch-sensing panel 430. As FIG. 6B shows, the Fresnel lens 300 located corresponding to the second flat panel 240 does not receive the original image to be transformed, and therefore the user will not observe any image from the second touch-sensing panel 440 and will not touch the second touch-sensing panel 440. In such a case, in order to save energy, the second touch-sensing panel 440 of the present embodiment can be temporarily switched off. Furthermore, in the present embodiment, the original images generated by the first flat panel 230 and the second flat panel 240 overlap with each other, but are not limited thereto; in different embodiments, the original images can partly or completely overlap depending on the arrangement of the panels 230, 240.

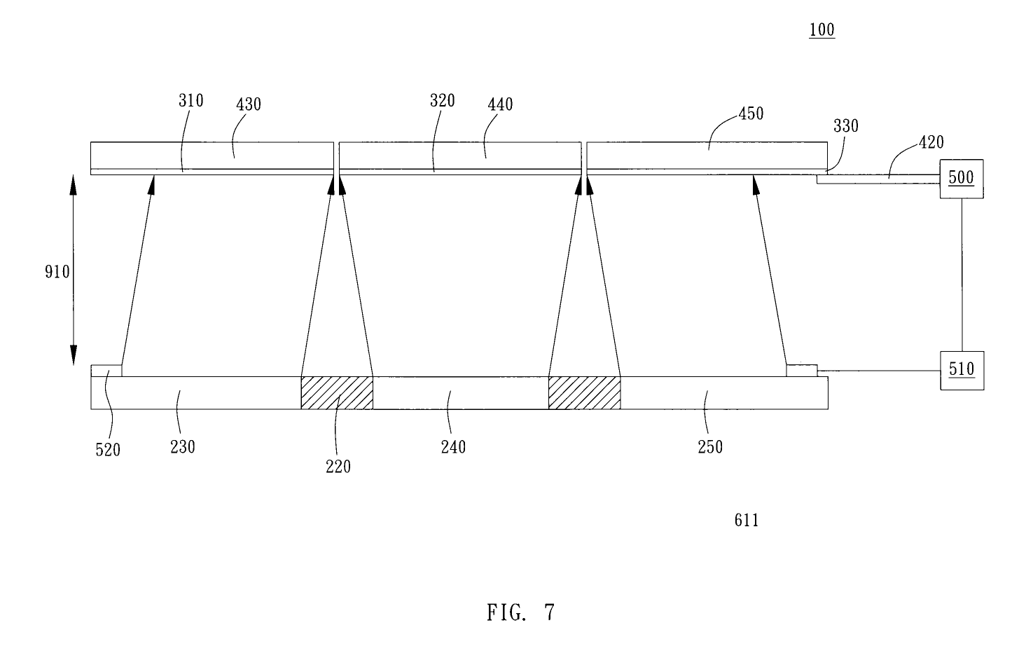

FIG. 7 illustrates another variation embodiment of the touch display panel 100 in FIG. 6A. In the present embodiment, the touch-sensing panel 400 includes a first touch-sensing panel 430, a second touch-sensing panel 440, and a third touch-sensing panel 450 while the flat display panel 200 includes a first flat panel 230, a second flat panel 240, and a third panel 250. The Fresnel lens 300 includes a first lens 310, a second lens 320, and a third lens 330 corresponding to the touch-sensing panels 430, 440, 450, respectively. As FIG. 7 shows, the first lens 310 and the third lens 330 shift the original images generated by the first flat panel 230 and the third panel 250 while the second lens 320 is used to magnify the original image generated by the second flat panel 240. Thus it can be seen that the Fresnel lens 300 is used to perform two kinds of optical image processing to generate the display images to conceal the spacer 220.

As FIG. 7 shows, the first lens 310 and the third lens 330 simultaneously shift the image, and therefore when the touch point is located on either the first touch-sensing panel 430 or the third touch-sensing panel 450, the coordinate transforming module 500 will use the shift parameter k to transform the display coordinate of the touch point into the original coordinate of the action point which is based on the original coordinate system. On the other hand, if the touch point is located on the second touch-sensing panel 440, the coordinate transforming module 500 will use a magnification parameter α to transform the display coordinate of the touch point A into the original coordinate of the action point C. In other words, the coordinate transforming module 500 will selectively use the shift parameter k or the magnification parameter α for coordinate transformation based on the location of the touch point.

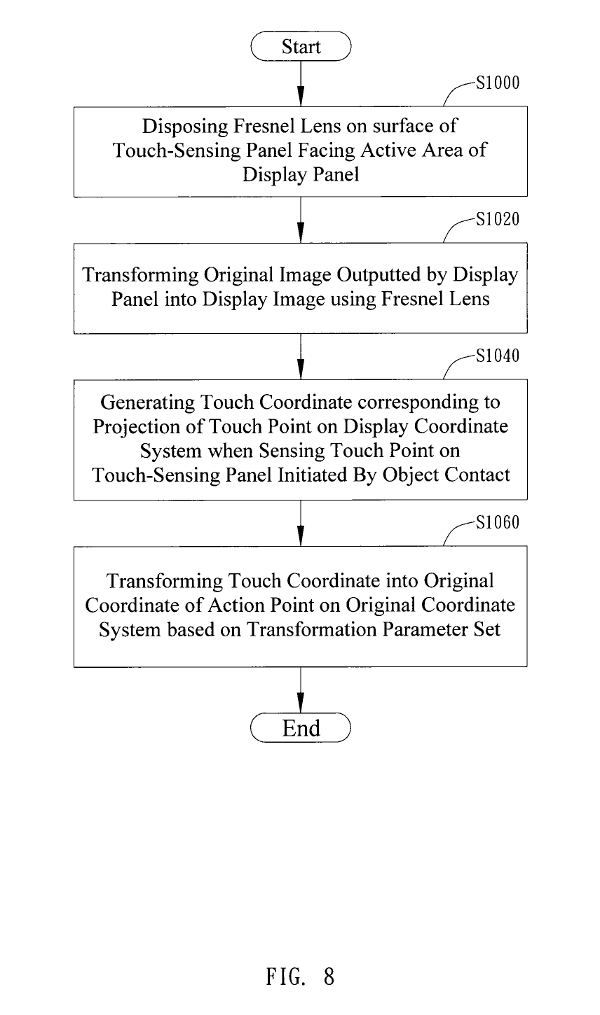

FIG. 8 is a flow chart of the touch sensing method of the present invention. The touch sensing method of the present invention includes step S1000 of disposing a Fresnel lens on the surface of the touch-sensing panel facing the active area of the flat display panel, wherein the Fresnel lens and the active area are spaced apart by a distance. In the present embodiment, the distance between the Fresnel lens and the active are is 3 mm, but is not limited thereto. Furthermore, in the present embodiment, the Fresnel lens and the active area are used in a touch display panel and are spaced apart by a fixed distance. However, in different embodiments, the above-mentioned distance can be adjusted according to the structure of the touch display panel and the using status. The touch-sensing panel and the flat display panel of the present embodiment are located at two opposite sides of the Fresnel lens. Furthermore, the touch-sensing panel of the present embodiment is a capacitive touch-sensing panel, but is not limited thereto; in different embodiments, the touch-sensing panel can include resistive touch-sensing panels, surface acoustic wave touch-sensing panels, infrared touch-sensing panels, or other types of touch-sensing panels.

Step S1020 includes transforming an original image outputted by the flat display panel into a display image using the Fresnel lens. In the present embodiment, the original image and the display image have an original coordinate system and a display coordinate system, respectively. The active area of the flat display panel outputs the original image to one side of the Fresnel lens and the original image will be transformed into the display image which exits from the opposite side of the Fresnel lens so that the display image will be the image viewed by the user. In the present embodiment, the Fresnel lens can be used to magnify images. Moreover, the Fresnel lens and the active area are spaced apart by a distance. In this way, the display image is an effectively magnified original image, but is not limited thereto; in different embodiments, the Fresnel lens can be used to shift images or shift and magnify images simultaneously.

The touch sensing method of the invention further includes step S1040 of generating a touch coordinate corresponding to a projection of the touch point on the display coordinate system when sensing a touch point on the touch-sensing panel initiated by an object contact and step S1060 of transforming the touch coordinate into an original coordinate of an action point on the original coordinate system based on a transformation parameter set. In the present embodiment, the object contact is made by user's finger, but is not limited thereto; in different embodiments, the object contact can be made using a stylus or other tools that can induce reactions by the touch-sensing panel.

Steps S1040 and S1060 aim at transforming the touch coordinate on the display system into the original coordinate on the original coordinate system based on a transformation parameter set. In this way, the touch sensing method of the present invention can avoid incorrectly identifying user's touch. In the present embodiment, the touch-sensing panel is connected to a coordinate transforming module to which the coordinate of touch point is transmitted. Furthermore, the transformation parameter set is stored in the coordinate transforming module and is used as a reference for coordinate transformation. In the present embodiment, the Fresnel lens generates the display images by shifting the original image. Furthermore, the transformation parameter set includes a shift parameter used to compensate for the shift or positional difference between the original image and the display image.

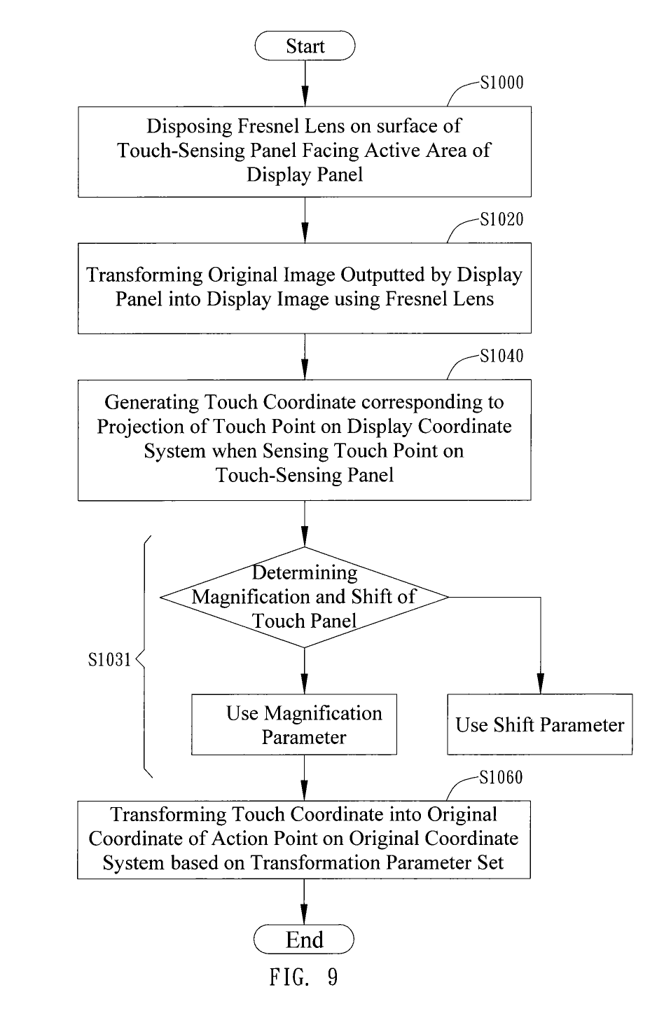

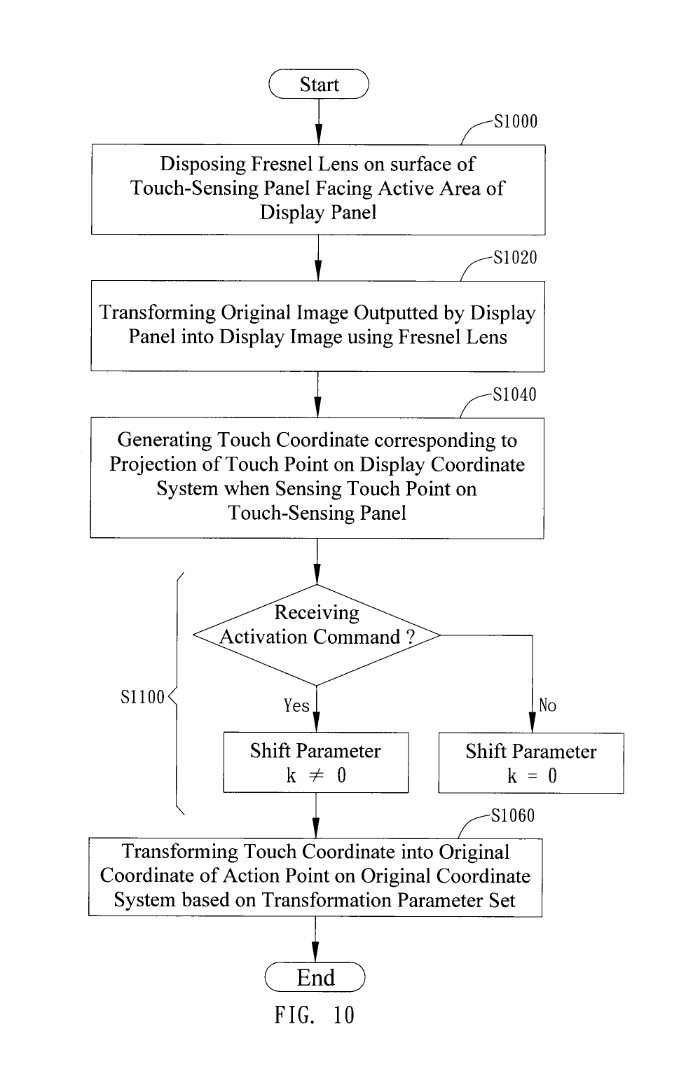

FIG. 9 illustrates a variation embodiment of the touch-sensing method illustrated in FIG. 8, wherein the variation embodiment includes step S1031 of transforming the touch coordinate according to at least one of a magnification parameter and a shift parameter of the transformation parameter set. In the present embodiment, the Fresnel lens can be used to magnify and shift images simultaneously; in other words, the original image can be selectively magnified or shifted into a display image. Therefore, step S1031 includes selectively using the magnification parameter or the shift parameter of the transformation parameter set based on the function of the Fresnel lens. In the present embodiment, the Fresnel lens includes a plurality of lenses used to magnify or shift the original image generated by the flat display panel. Furthermore, different lenses correspond to different portions of the touch-sensing panel 400, and therefore different locations on the touch-sensing panel 400 may require different parameters for coordinate transformation. Thus, in different embodiments, step S1031 includes selectively using the shift parameter or the magnification parameter for coordinate transformation based on the location of the touch point.

FIG. 10 illustrates another embodiment of the touch-sensing method, wherein the touch-sensing method further includes setting the transformation parameter set at a standard value or a default value. In the present embodiment, the touch display panel further includes a sensor and an activation module, wherein the activation module is electrically connected to the coordinate transforming module and outputs an activation command to set the transformation parameter set at a standard value or a default value. The sensor is used to sense the distance between the flat display panel and the Fresnel lens to control the activation module to output the activation command. As FIG. 10 shows, the touch-sensing method include step S1100 of controlling the activation module to set the transformation parameter set at the standard value when detecting the distance between the flat display panel and the Fresnel lens beyond a predetermined value. In the present embodiment, when the sensor detects the distance between the flat display panel and Fresnel lens beyond the predetermined value, the sensor will instruct the activation module to set the transformation parameter set at the standard value. In the embodiment illustrated in FIG. 10, when the transformation parameter set is set at the standard value, step S1100 will transform the coordinate of the touch point according to a shift parameter, but is not limited thereto; in different embodiments, step S1100 can selectively use the shift parameter and the magnification parameter simultaneously to transform the coordinates of the touch points.

Furthermore, step S1100 illustrated in FIG. 10 further includes generating the activation command to set the transformation parameter set at the default value when detecting the distance between the flat display panel and the Fresnel lens less than a given value. In the present embodiment, when the sensor determines that the distance between the flat display panel and the Fresnel lens is smaller than a certain distance, the sensor will control the activation module to output an activation command to the coordinate transforming module to set the transformation parameter set at the default value. In the present embodiment, the Fresnel lens is used to generate the display image by shifting the original image. Therefore, step S1100 involves using a shift parameter k for coordinate transformation. When the transformation parameter set is set at the default value, step S1100 will set the shift parameter k at 0 to reduce the positional difference between the display coordinate system and the original coordinate system. In other words, the Fresnel lens substantially does not shift the original image when the transformation parameter set is set at the default value, and step S1100 reduces the positional difference between the original coordinate system and the display coordinate system to substantially zero by setting the transformation parameter set at the default value.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A touch display panel, comprising:
a flat display panel having an active area, wherein the active area outputs an original image having an original coordinate system;
a Fresnel lens, disposed on a side of the flat display panel having the active area and spaced apart from the active area by a distance, wherein the Fresnel lens transforms the original image into a display image having a display coordinate system, a positional difference exists between the original coordinate system and the display coordinate system;
a touch-sensing panel disposed on an outer surface of the Fresnel lens, wherein the touch-sensing panel outputs a touch coordinate of a touch point projected on the display coordinate system when detecting a touch on the touch point; and
a coordinate transforming module electrically connected to the touch-sensing panel to receive the touch coordinate, wherein the coordinate transforming module stores a transformation parameter set and transforms the touch coordinate into an action coordinate of the original coordinate system based on the transformation parameter set.

2. The touch display panel of claim 1, wherein the transformation parameter set includes a magnification parameter.

3. The touch display panel of claim 1, wherein the transformation parameter set includes a shift parameter.

4. The touch display panel of claim 1, wherein the transformation parameter set includes a magnification parameter and a horizontal shift parameter.

5. The touch display panel of claim 1, wherein the touch-sensing panel includes a touch-sensing circuit for generating the touch coordinate based on the touch, the coordinate transforming module is embedded in the touch-sensing circuit.

6. The touch display panel of claim 1, wherein the touch-sensing panel includes a touch-sensing circuit for generating the touch coordinate based on the touch, the coordinate transforming module is disposed independent of the touch-sensing circuit.

7. The touch display panel of claim 1, further comprising an activation module electrically connected to the coordinate transforming module, wherein the activation module selectively sets the transformation parameter set at a standard value based on an activation command and then transforms the touch coordinate into the action coordinate or selectively set the transformation parameter set at a default value so that the positional difference between the display coordinate system and the original coordinate system is 0.

8. The touch display panel of claim 7, wherein the activation module includes a sensor disposed between the flat display panel and the Fresnel lens, the sensor generates the activation command to set the transformation parameter set at the standard value when detecting the distance between the flat display panel and the Fresnel lens beyond a predetermined value.

9. The touch display panel of claim 8, wherein the sensor is electrically connected to the coordinate transforming module and generates distance data based on the distance.

10. The touch display panel of claim 9, wherein the sensor selectively generates the distance data in a dynamic or periodic manner.

11. The touch display panel of claim 8, when the sensor sets the transformation parameter set at the default value when the sensor determines that the distance between the flat display panel and the Fresnel lens is smaller than a given value.

12. The touch display panel of claim 1, wherein the flat display panel includes a first flat panel and a second flat panel disposed side by side, the touch-sensing panel includes a first touch-sensing panel and a second touch-sensing panel selectively corresponding to one of the first flat panel and the second flat panel or respectively corresponding to the first flat panel and the second flat panel, the transformation parameter set includes a first shift parameter for shifting the touch coordinate corresponding to the first touch-sensing panel to be closer to the second touch-sensing panel than the action coordinate.

13. The touch display panel of claim 1, wherein the flat display panel includes a first flat panel and a second flat panel at least partly overlapping each other, the touch-sensing panel includes a first touch-sensing panel and a second touch-sensing panel respectively selectively corresponding to one of the first flat panel and the second flat panel or respectively corresponding to the first flat panel and the second flat panel, the transformation parameter set includes a first shift parameter for shifting the touch coordinate corresponding to the first touch-sensing panel to be closer to the second touch-sensing panel than the action coordinate.

14. The touch display panel of claim 12 or 13, wherein the original image includes a first original image and a second original image outputted by the first flat panel and the second flat panel respectively, the first original image and the second original image between the active area and the Fresnel lens at least partly overlap each other.

15. The touch display panel of claim 12, wherein the display coordinate system includes a first coordinate system and a second coordinate system corresponding to the first touch-sensing panel and the second touch-sensing panel, respectively.

16. The touch display panel of claim 12, wherein the first flat panel includes a thin-film transistor liquid crystal panel, an electrophoretic display, or a print button.

17. The touch display panel of claim 12, wherein the second flat panel includes a thin-film transistor liquid crystal panel, an electrophoretic display, or a print button.

18. The touch display panel of claim 12, wherein the transformation parameter set includes a second shift parameter for shifting a portion of the display coordinate system corresponding to the second touch-sensing panel to be closer to the first touch-sensing panel than a portion of the original coordinate system corresponding to the second flat panel.

19. The touch display panel of claim 12, wherein the transformation parameter set includes a magnification parameter for making a distance between the first touch-sensing panel and a portion the display coordinate system corresponding to the second touch-sensing panel be smaller than a distance between the first flat panel and a portion of the original coordinate system corresponding to the second flat panel.

20. The touch display panel of claim 12, wherein the flat display panel further includes a third panel disposed side by side with the first flat panel and the second flat panel, the third panel and the first flat panel are located at two opposite sides of the second flat panel, the touch-sensing panel includes a third touch-sensing panel corresponding to the third panel, the transformation parameter set includes a third shift parameter for shifting a portion of the display coordinate system corresponding to the third touch-sensing panel to be closer to the first touch-sensing panel than a portion of the original coordinate system corresponding to the third panel.

21. A touch sensing method for a touch display panel including following steps:
disposing a Fresnel lens at a side of a flat display panel having an active area, wherein a distance exists between the Fresnel lens and an active area of the flat display panel;
disposing a touch-sensing panel at one side of the Fresnel lens opposite to the flat display panel;
transforming an original image outputted by the flat display panel into a display image using the Fresnel lens, wherein the original image has an original coordinate system and the display image has a display coordinate system, a positional difference exits between the original coordinate system and the display coordinate system;
sensing a touch point using the touch-sensing panel and correspondingly generating a touch coordinate corresponding to a projection of the touch point on the display coordinate system; and
transforming the touch coordinate into an action coordinate on the original coordinate system based on a transformation parameter set.

22. The touch sensing method of claim 21, wherein the step of transforming coordinate includes transforming the touch coordinate according to a magnification parameter of the transformation parameter set.

23. The touch sensing method of claim 21, wherein the step of transforming coordinate includes transforming the touch coordinate according to a shift parameter of the transformation parameter set.

24. The touch sensing method of claim 21, wherein the step of transforming coordinate includes transforming the touch coordinate according to a magnification parameter and a shift parameter of the transformation parameter set.

25. The touch sensing method of claim 21, further including setting the transformation parameter set at a standard value according to an activation command for a transformation between the touch coordinate and the action coordinate or setting the transformation parameter set at a default value so that the positional difference between the display coordinate system and the original coordinate system is 0.

26. The touch sensing method of claim 25, further including generating the activation command for setting the transformation parameter set at the standard value when detecting the distance between the flat display panel and the Fresnel lens beyond a predetermined value.

27. The touch sensing method of claim 26, wherein the step of generating the activation command includes generating the activation command for setting the transformation parameter set at the default value when determining that the distance between the flat display panel and the Fresnel lens is smaller than a given value.
